(19) United States
(12) Patent Application Publication
(10) Pub. No.: US 2004/0174364 A1
(43) Pub. Date: Sep. 9, 2004

(54) Rendering patterned lines in a graphics system

(76) Inventors: Patrick D. Shehane, Fremont, CA (US); Michael G. Lavelle, Saratoga, CA (US); Mark E. Pascual, San Jose, CA (US); Wing-Cheong Tang, Union City, CA (US); Nandini Ramani, Saratoga, CA (US)

Correspondence Address: Jeffrey C. Hood, Meyertons, Hood, Kivlin, Kowert & Goetzel PC, P.O. Box 398, Austin, TX, 78767, US

(21) Appl. No.: 10/378,560

(22) Filed: Mar. 3, 2003

(51) Int. Cl. G06T 11/20

(52) U.S. Cl. 345/443

(57) ABSTRACT

The method for line patterning may include receiving line data for a first line. The line data for the first line may include an original starting point and an original endpoint. The first line may be divided into one or more line segments, which may include generating a new starting point and a new endpoint for one or more of the one or more line segments. The new line segments may then be rasterized from the new endpoint to the new starting point. In other words, each line segment may be rasterized from right to left, thus avoiding problems associated with multiple consecutive accesses of pixel addresses in the pixel buffer. The original or intended line pattern of the line is preserved since the zeros and ones are drawn or rendered in their appropriate locations as if they were being drawn left to right, even though they are actually rasterized from right to left.

### BACKGROUND OF THE INVENTION

1. Field of the Invention

This invention relates generally to the field of computer graphics and, more particularly, to rendering lines in a graphics system.

2. Description of the Related Art

A computer system typically relies upon its graphics system for producing visual output on the computer screen or display device. Early graphics systems were only responsible for taking what the processor produced as output and displaying it on the screen. In essence, they acted as simple translators or interfaces. Modern graphics systems, however, incorporate graphics processors with a great deal of processing power. They now act more like coprocessors rather than simple translators. This change is due to the recent increase in both the complexity and amount of data being sent to the display device. For example, modern computer displays have many more pixels, greater color depth, and are able to display more complex images with higher refresh rates than earlier models. Similarly, the images displayed are now more complex and may involve advanced techniques such as anti-aliasing and texture mapping.

As a result, without considerable processing power in the graphics system, the CPU would spend a great deal of time performing graphics calculations. This could rob the computer system of the processing power needed for performing other tasks associated with program execution and thereby dramatically reduce overall system performance. With a powerful graphics system, however, when the CPU is instructed to draw a box on the screen, the CPU is freed from having to compute the position and color of each pixel. Instead, the CPU may send a request to the video card stating “draw a box at these coordinates.” The graphics system then draws the box, freeing the processor to perform other tasks.

Generally, a graphics system in a computer (also referred to as a graphics system) is a type of a video adapter that contains its own processor to boost performance levels. These processors are specialized for computing graphical transformations, so they tend to achieve better results than the general-purpose CPUs used by the computer system. In addition, they free up the computer's CPU to execute other commands while the graphics system is handling graphics computations. The popularity of graphical applications, and especially multimedia applications, has made high performance graphics systems a common feature of computer systems. Most computer manufacturers now bundle a high performance graphics system with their systems.

Since graphics systems typically perform only a limited set of functions, they may be customized and therefore far more efficient at graphics operations than the computer's general-purpose central processor. While early graphics systems were limited to performing two-dimensional (2D) graphics, their functionality has increased to support three-dimensional (3D) wire-frame graphics, 3D solids, and now includes support for three-dimensional (3D) graphics with textures and special effects such as advanced shading, fogging, alpha-blending, and specular highlighting.

A modern graphics system may generally operate as follows. First, graphics data is initially read from a computer system's main memory into the graphics system. The graphics data may include geometric primitives such as polygons (e.g., triangles), NURBS (Non-Uniform Rational B-Splines), sub-division surfaces, voxels (volume elements) and other types of data. The various types of data are typically converted into triangles (e.g., three vertices having at least position and color information). Then, transform and lighting calculation units receive and process the triangles. Transform calculations typically include changing a triangle's coordinate axis, while lighting calculations typically determine what effect, if any, lighting has on the color of triangle's vertices. The transformed and lit triangles may then be conveyed to a clip test/back face culling unit that determines which triangles are outside the current parameters for visibility (e.g., triangles that are off screen). These triangles are typically discarded to prevent additional system resources from being spent on non-visible triangles.

Next, the triangles that pass the clip test and back-face culling may be translated into screen space. The screen space triangles may then be forwarded to the set-up and draw processor for rasterization. Rasterization typically refers to the process of generating actual pixels (or samples) by interpolation from the vertices. The rendering process may include interpolating slopes of edges of the polygon or triangle, and then calculating pixels or samples on these edges based on these interpolated slopes. Pixels or samples may also be calculated in the interior of the polygon or triangle.

As noted above, in some cases samples are generated by the rasterization process instead of pixels. A pixel typically has a one-to-one correlation with the hardware pixels present in a display device, while samples are typically more numerous than the hardware pixel elements and need not have any direct correlation to the display device. Where pixels are generated, the pixels may be stored into a frame buffer, or possibly provided directly to refresh the display. Where samples are generated, the samples may be stored into a sample buffer or frame buffer. The samples may later be accessed and filtered to generate pixels, which may then be stored into a frame buffer, or the samples may be possibly filtered to form pixels that are provided directly to refresh the display without any intervening frame buffer storage of the pixels.

The pixels are converted into an analog video signal by digital-to-analog converters. If samples are used, the samples may be read out of sample buffer or frame buffer and filtered to generate pixels, which may be stored and later conveyed to digital to analog converters. The video signal from converters is conveyed to a display device such as a computer monitor, LCD display, or projector.

### Prior Art Line Patterning—FIGS. 1-3

The rendering process may include rendering lines for display. One typical graphics operation involves rendering polylines or patterned lines for display. Exemplary patterned lines include dashed lines, dotted lines, and combinations thereof. In many instances, lines are drawn as a series of line segments. The line segments are typically blended or anti-aliased to create a smooth, homogenous line without visual artifacts. Thus, in order to eliminate rendering artifacts in an image, it is important to properly filter the line endpoints to create a smooth line. One of the most important parts of endpoint filtering is to guarantee that when two line endpoints meet, they appear to be one continuous line. This is because lines are more often used as polylines to approximate a curve than as individual line segments not connected to other lines.

When lines are drawn left to right, in many instances the location where two lines meet involves multiple accesses to the same pixels in the frame buffer. This is due to the endpoint filtering performed at each of the line endpoints. However, it is undesirable to access or visit the same pixel twice consecutively in the frame buffer. This is because, after the first read-modify-write operation, the pixel data may require at least several memory clock cycles to flow through the memory and/or rendering pipeline before the new data is stored inside the frame buffer memory. A second read-modify-write operation can be issued to the same pixel only after the new data has been written in order to ensure data consistency between the write of the first read-modify-write and the read of the second read-modify-write. Hence, in any consecutive read-modify-write accesses to the same pixel location, a certain number of cycles may have to be inserted in between. This may reduce graphics performance.

In one example, FIGS. 1-3 illustrate an exemplary 1-D patterned line and its associated data. Line data for the exemplary 1-D line may include line pattern data, illustrated in FIG. 3, an original starting point and an original endpoint, as well as line scale data and line length (FIG. 2). The exemplary 1-D line may be divided into two lines: (10,10) to (20,10) and (20,10) to (30,10) or one line, depending on the capability of the graphics system.

In order to avoid this situation, a method is desired for drawing blended or anti-aliased lines that avoids visiting the same pixel twice in a short time period. It would also be desirable to draw patterned lines without sacrificing performance.

### SUMMARY OF THE INVENTION

The method for line patterning may include receiving line data for a first line. The line data for the first line may include an original starting point and an original endpoint. The first line may be divided into one or more line segments, which may include generating a new starting point and a new endpoint for one or more of the one or more line segments. The new line segments may then be rasterized, using the new starting point and the new endpoint.

Specifically, a number of consecutive zeros in the patterned line may be counted, starting at the original starting point. If one or more zeros are present at the beginning of the pattern, then these zeros may be counted to generate the number of zeros. If the pattern begins with a ‘1’, then no zeros may be counted. The number of zeros may be scaled based on the line scale data to produce a scaled number of zeros. The original starting point may be adjusted by a scaled number of zeros. A new starting color value may also be calculated. The new starting color value calculation may include adjusting the starting color value by one or more of the scaled number of zeros and the color slope of the first line. The x coordinate of the original starting point may be adjusted by the scaled number of zeros to generate the x coordinate of the new starting point. The y coordinate of the original starting point may be adjusted by the scaled number of zeros to generate the y coordinate of the new starting point.

A check may be performed to determine if the location of the new starting point exceeds the location of the original endpoint, or simply to determine if an entire line has been drawn. If the new starting point exceeds the location of the original endpoint, then operation may complete and exit. Specifically, the x coordinate of the original endpoint may be compared to the x coordinate of the new endpoint. If the x coordinate of the new endpoint is greater than the x coordinate of the original endpoint, than the x coordinate of the new endpoint may be set to the x coordinate of the original endpoint.

A consecutive number of ones may be counted in the line pattern data for the first line to generate a number of ones. Specifically, the consecutive number of ones that either begin the pattern or are after the previously counted zeros in the pattern may be counted. The number of ones may be scaled based on the line scale data for the first line.

The new endpoint may be calculated by adjusting the original starting point by the scaled number of ones. The x coordinate of the new endpoint may be calculated by adjusting the x coordinate of the original endpoint by the scaled number of ones. The y coordinate of the new endpoint may be calculated by adjusting the y coordinate of the original endpoint point by the scaled number of ones. In one embodiment, the new endpoint may be calculated by adjusting the y coordinate of the original endpoint by one or more of the scaled number of ones and slope of the first line.

The first line segment may be rasterized from the new endpoint to the new starting point. In other words, the first line segment may be rasterized from right to left, thus avoiding problems associated with multiple consecutive accesses of pixel addresses in the pixel buffer. The original or intended line pattern of the line is preserved since the zeros and ones are drawn or rendered in their appropriate locations as if they were being drawn left to right, even though they are actually rasterized from right to left. The new endpoint may be used as the next starting point for the next iteration of the line patterning algorithm.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 is a Prior Art general view of a patterned line illustrating direction of rendering as specified by software;

FIG. 2 illustrates an exemplary Prior Art parameter settings for an exemplary patterned line;

FIG. 3 illustrates an exemplary Prior Art renderization of an exemplary patterned line;

FIG. 4 is a perspective view of one embodiment of a computer system;

FIG. 5 is a simplified block diagram of one embodiment of a computer system;

FIG. 6 is a functional block diagram of one embodiment of a graphics system;

FIG. 7 is a functional block diagram of one embodiment of the media processor of FIG. 6;

FIG. 8 is a functional block diagram of one embodiment of the hardware accelerator of FIG. 6;

FIG. 9 is a functional block diagram of one embodiment of the video output processor of FIG. 6;

FIG. 10 illustrates rendering of samples in a triangle, according to one embodiment;

FIG. 11 illustrates an exemplary patterned line, according to one embodiment;

FIG. 12 is a flowchart of a method for line patterning, according to one embodiment;

FIG. 13 illustrates an exemplary 1-D patterned line, according to one embodiment;

FIG. 14A and 14B illustrate exemplary segmentation of a 1-D patterned line into one or more segments, according to one embodiment; and

FIG. 15 illustrates sample pseudo-code of a method for line patterning, according to one embodiment.

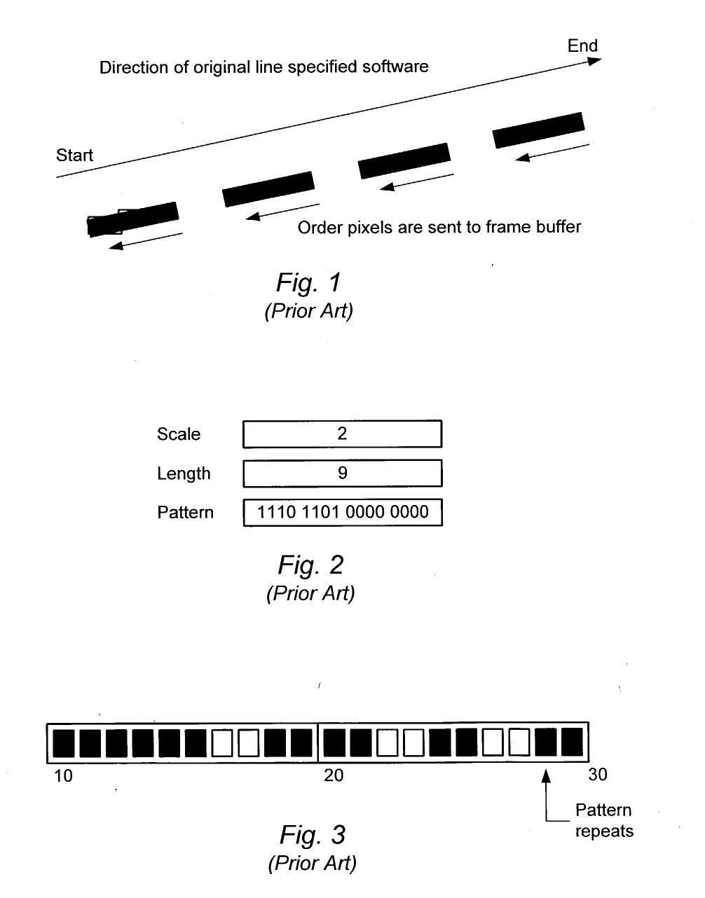

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

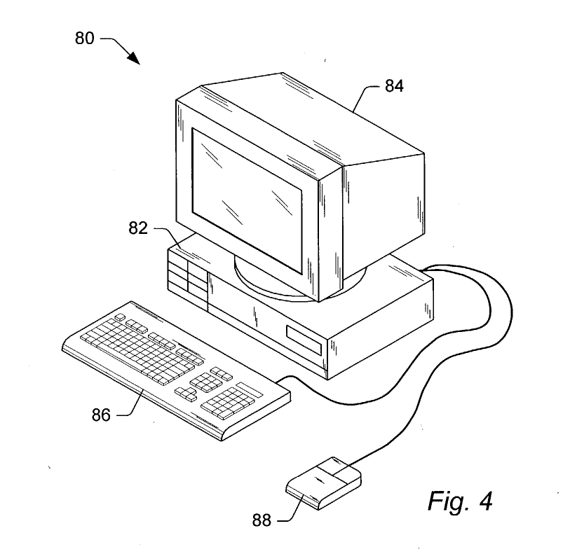

### Computer System—FIG. 4

FIG. 4 illustrates one embodiment of a computer system 80 that includes a graphics system. The graphics system may be included in any of various systems such as computer systems, network PCs, Internet appliances, televisions (e.g. HDTV systems and interactive television systems), personal digital assistants (PDAs), virtual reality systems, and other devices which display 2D and/or 3D graphics, among others.

As shown, the computer system 80 includes a system unit 82 and a video monitor or display device 84 coupled to the system unit 82. The display device 84 may be any of various types of display monitors or devices (e.g., a CRT, LCD, or gas-plasma display). Various input devices may be connected to the computer system, including a keyboard 86 and/or a mouse 88, or other input device (e.g., a trackball, digitizer, tablet, six-degree of freedom input device, head tracker, eye tracker, data glove, or body sensors). Application software may be executed by the computer system 80 to display graphical objects on the display device 84.

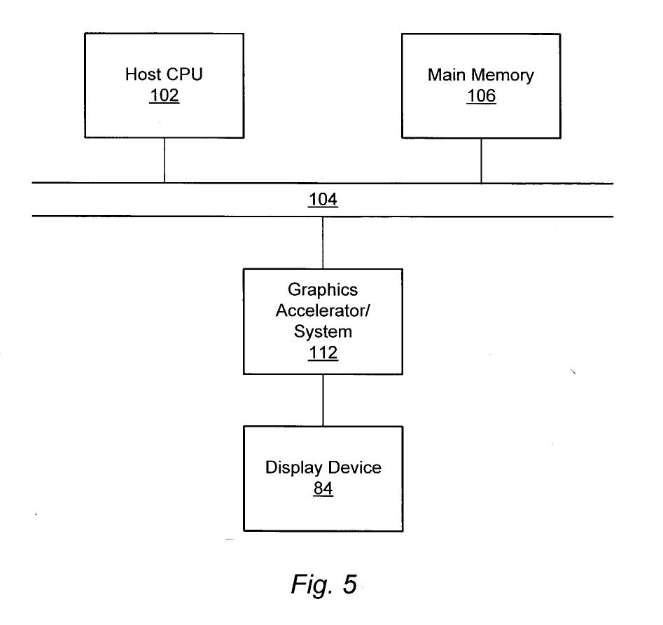

### Computer System Block Diagram—FIG. 5

FIG. 5 is a simplified block diagram illustrating the computer system of FIG. 5, according to one embodiment. As shown, the computer system 80 includes a central processing unit (CPU) 102 coupled to a high-speed memory bus or system bus 104 also referred to as the host bus 104. A system memory 106 (also referred to herein as main memory) may also be coupled to the high-speed bus 104.

Host processor 102 may include one or more processors of varying types, e.g., microprocessors, multi-processors and CPUs. The system memory 106 may include any combination of different types of memory subsystems such as random access memories (e.g., static random access memories or “SRAMs,” synchronous dynamic random access memories or “SDRAMs,” and Rambus dynamic random access memories or “RDRAMs,” among others), read-only memories, and mass storage devices. The system bus or host bus 104 may include one or more communication or host computer buses (for communication between host processors, CPUs, and memory subsystems) as well as specialized subsystem buses.

In FIG. 5, a graphics system 112 is coupled to the high-speed memory bus 104. The graphics system 112 may be coupled to the bus 104 by, for example, a crossbar switch or other bus connectivity logic. It is assumed that various other peripheral devices, or other buses, may be connected to the high-speed memory bus 104. It is noted that the graphics system 112 may be coupled to one or more of the buses in computer system 80 and/or may be coupled to various types of buses. In addition, the graphics system 112 may be coupled to a communication port and thereby directly receive graphics data from an external source, e.g., the Internet or a network. As shown in the figure, one or more display devices 84 may be connected to the graphics system 112.

The host CPU 102 may transfer information to and from the graphics system 112 according to a programmed input/output (I/O) protocol over the host bus 104. Alternately, the graphics system 112 may access system memory 106 according to a direct memory access (DMA) protocol or through intelligent bus mastering.

A graphics application program conforming to an application programming interface (API) such as OpenGL® or Java 3D™ may execute on the host CPU 102 and generate commands and graphics data that define geometric primitives such as polygons for output on display device 84. The host processor 102 may transfer the graphics data to the system memory 106. Thereafter, the host processor 102 may operate to transfer the graphics data to the graphics system 112 over the host bus 104. In another embodiment, the graphics system 112 may read in geometry data arrays over the host bus 104 using DMA access cycles. In yet another embodiment, the graphics system 112 may be coupled to the system memory 106 through a direct port, such as the Advanced Graphics Port (AGP) promulgated by Intel Corporation.

The graphics system may receive graphics data from any of various sources, including the host CPU 102 and/or the system memory 106, other memory, or from an external source such as a network (e.g. the Internet), or from a broadcast medium, e.g., television, or from other sources.

Note that while the graphics system 112 is depicted as part of a computer system 80, the graphics system 112 may also be configured as a stand-alone device (e.g., with its own built-in display). The graphics system 112 may also be configured as a single chip device or as part of a system-on-a-chip or a multi-chip module. Additionally, in some embodiments, certain of the processing operations performed by elements of the illustrated the graphics system 112 may be implemented in software.

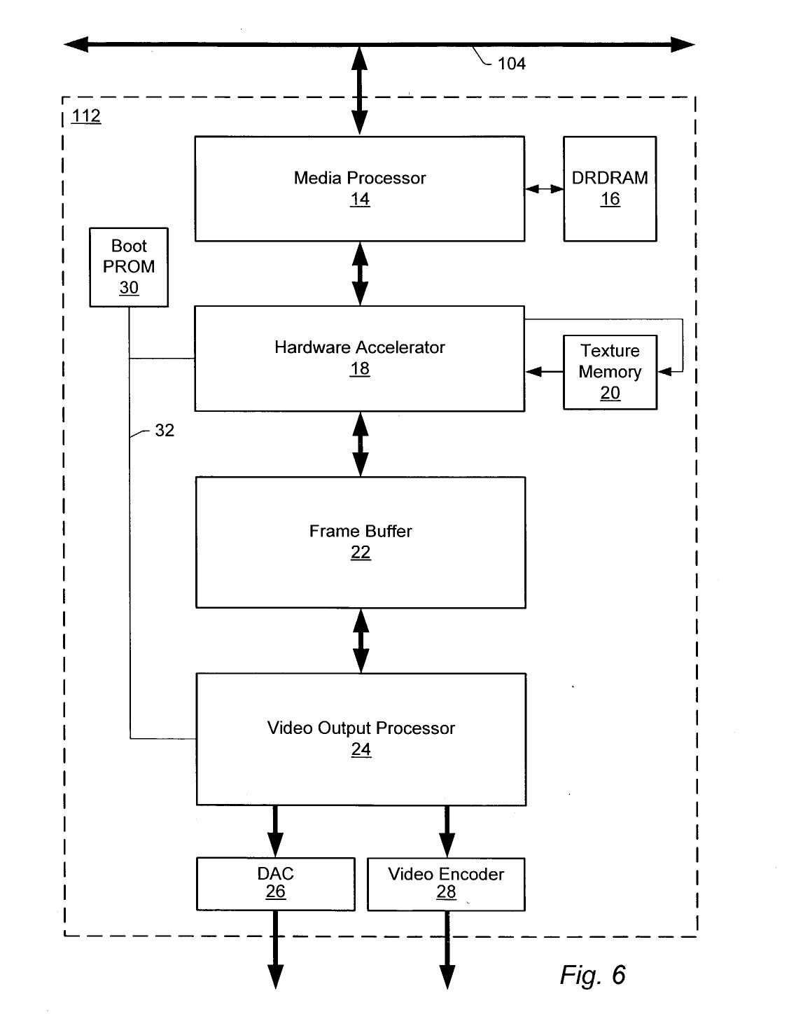

### Graphics System—FIG. 6

FIG. 6 is a functional block diagram illustrating one embodiment of a graphics system 112, according to one embodiment. Note that many other embodiments of graphics system 112 are possible and contemplated. The graphics system 112 may include one or more media processors 14, one or more hardware accelerators 18, one or more texture buffers 20, one or more frame buffers 22, and one or more video output processors 24, besides others. The graphics system 112 may also include one or more output devices such as digital-to-analog converters (DACs) 26, video encoders 28, flat-panel-display drivers (not shown), and/or video projectors (not shown), besides others. The media processor 14 and/or the hardware accelerator 18 may include any suitable type of high performance processor (e.g., specialized graphics processors or calculation units, multimedia processors, DSPs, or general purpose processors).

In some embodiments, one or more of these components may be removed. For example, the texture buffer may not be included in an embodiment that does not provide texture mapping. In other embodiments, all or part of the functionality incorporated in either or both of the media processor or the hardware accelerator may be implemented in software.

In one set of embodiments, media processor 14 is one integrated circuit and hardware accelerator is another integrated circuit. In other embodiments, media processor 14 and hardware accelerator 18 may be incorporated within the same integrated circuit. In some embodiments, portions of media processor 14 and/or hardware accelerator 18 may be included in separate integrated circuits.

As shown, the graphics system 112 may include an interface to a host bus such as host bus 104 in FIG. 5 to enable the graphics system 112 to communicate with a host system such as the computer system 80. More particularly, the host bus 104 may allow a host processor to send commands to the graphics system 112. In one embodiment, the host bus 104 may be a bi-directional bus.

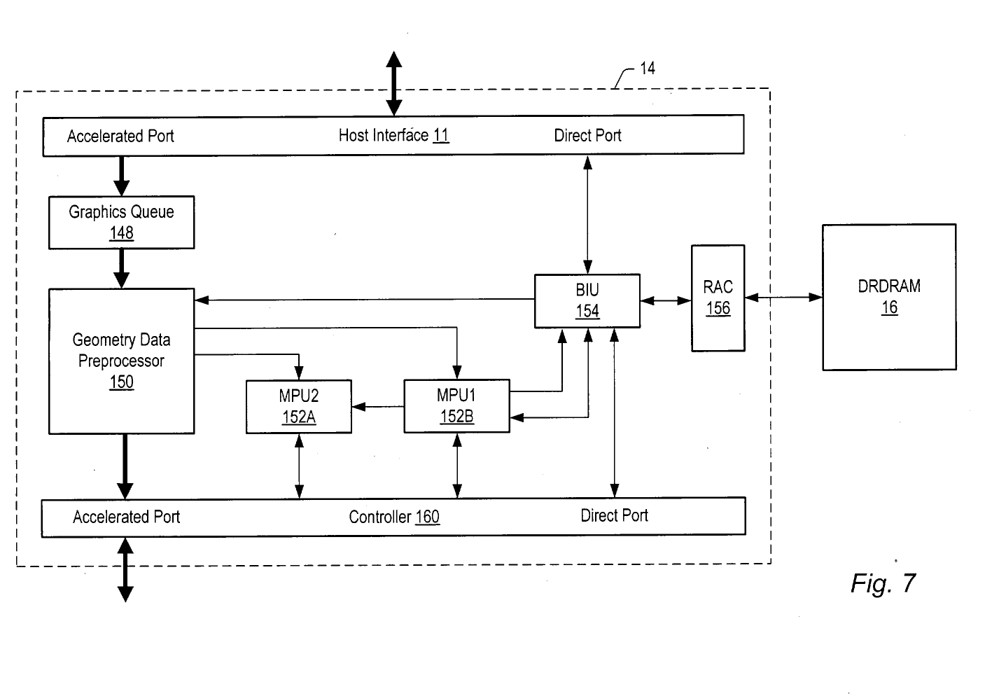

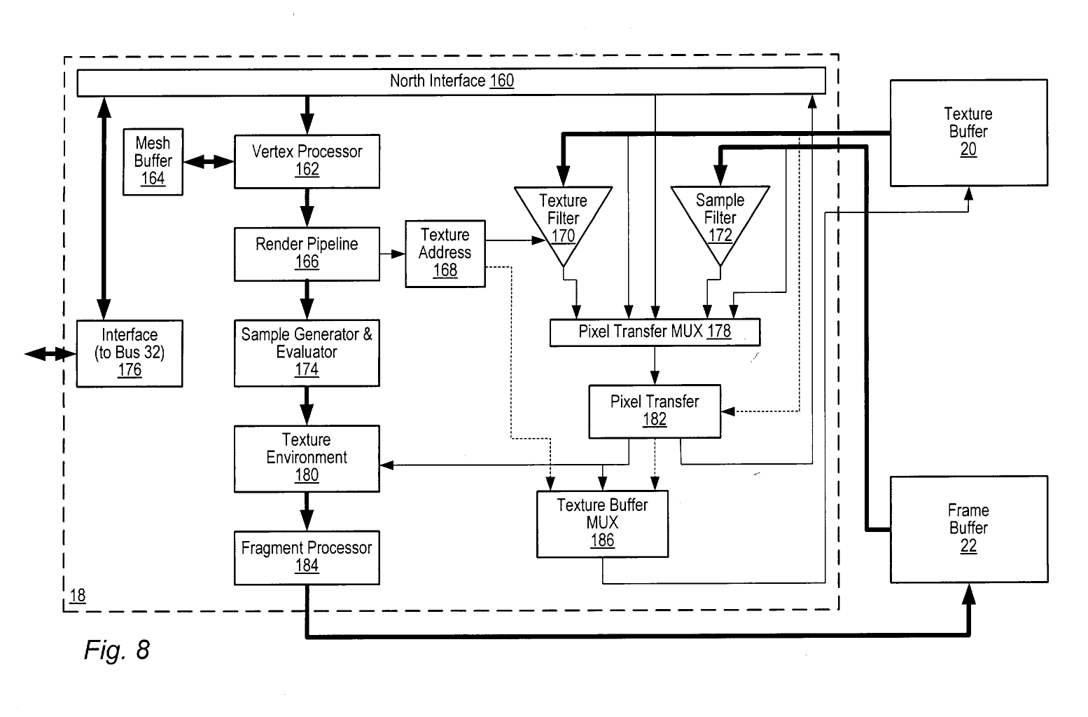

### Media Processor—FIG. 7

FIG. 7 shows one embodiment of a media processor 14. As shown, media processor 14 may operate as the interface between a graphics system 112 and a computer system 80 by controlling the transfer of data between the computer system 80 and the graphics system 112. In some embodiments, media processor 14 may also be configured to perform transformations, lighting, and/or other general-purpose processing operations on graphics data.

Transformation refers to the spatial manipulation of objects (or portions of objects) and includes translation, scaling (e.g. stretching or shrinking), rotation, reflection, or combinations thereof. More generally, transformation may include linear mappings (e.g. matrix multiplications), nonlinear mappings, and combinations thereof.

Lighting refers to calculating the illumination of the objects within the displayed image to determine what color values and/or brightness values each individual object will have. Depending upon the shading algorithm being used (e.g., constant, Gourand, or Phong), lighting may be evaluated at a number of different spatial locations.

As illustrated, media processor 14 may be configured to receive graphics data via host interface 11. A graphics queue 148 may be included in the media processor 14 to buffer a stream of data received via the accelerated port of the host interface 11. The received graphics data may include one or more graphics primitives. As used herein, the term graphics primitive may include polygons, parametric surfaces, splines, NURBS (non-uniform rational B-splines), sub-divisions surfaces, fractals, volume primitives, voxels (i.e., three-dimensional pixels), and particle systems. In one embodiment, media processor 14 may also include a geometry data preprocessor 150 and one or more microprocessor units (MPUs) 152. The MPUs 152 may be configured to perform vertex transformation, lighting calculations and other programmable functions, and to send the results to hardware accelerator 18. The MPUs 152 may also have read/write access to texels (i.e. the smallest addressable unit of a texture map) and pixels in the hardware accelerator 18. Geometry data preprocessor 150 may be configured to decompress geometry, to convert and format vertex data, to dispatch vertices and instructions to the MPUs 152, and to send vertex and attribute tags or register data to hardware accelerator 18.

As shown, media processor 14 may have other possible interfaces, including an interface to one or more memories. For example, as shown, the media processor 14 may include direct Rambus interface 156 to a direct Rambus DRAM (DRDRAM) 16. A memory such as the DRDRAM 16 may be used for program and/or data storage for MPUs 152. The DRDRAM 16 may also be used to store display lists and/or vertex texture maps.

Media processor 14 may also include interfaces to other functional components of graphics system 112. For example, the media processor 14 may have an interface to another specialized processor such as a hardware accelerator 18. In the illustrated embodiment, controller 160 includes an accelerated port path that allows the media processor 14 to control the hardware accelerator 18. The media processor 14 may also include a direct interface such as a bus interface unit (BIU) 154. The bus interface unit 154 may provide a path to memory 16 and a path to hardware accelerator 18 and video output processor 24 via controller 160.

### Hardware Accelerator—FIG. 8

One or more hardware accelerators 18 may be configured to receive graphics instructions and data from media processor 14 and to perform a number of functions on the received data according to the received instructions. For example, hardware accelerator 18 may be configured to perform rasterization, 2D and/or 3D texturing, pixel transfers, imaging, fragment processing, clipping, depth cueing, transparency processing, set-up, and/or screen space rendering of various graphics primitives occurring within the graphics data.

Clipping refers to the elimination of graphics primitives or portions of graphics primitives that lie outside of a 3D view volume in world space. The 3D view volume may represent that portion of world space that is visible to a virtual observer (or virtual camera) situated in world space. For example, the view volume may be a solid truncated pyramid generated by a 2D view window, a viewpoint located in world space, a front clipping plane and a back clipping plane. The viewpoint may represent the world space location of the virtual observer. In most cases, primitives or portions of primitives that lie outside the 3D view volume are not currently visible and may be eliminated from further processing. Primitives or portions of primitives that lie inside the 3D view volume are candidates for projection onto the 2D view window.

Set-up refers to mapping primitives to a three-dimensional viewport. This involves translating and transforming the objects from their original “world-coordinate” system to the established viewport's coordinates. This creates the correct perspective for three-dimensional objects displayed on the screen.

Screen-space rendering refers to the calculations performed to generate the data used to form each pixel that will be displayed. For example, hardware accelerator 18 may calculate “samples.” Samples are points that have color information but no real area. Samples allow the hardware accelerator 18 to “super-sample,” or calculate more than one sample per pixel. Super-sampling may result in a higher quality image.

Hardware accelerator 18 may also include several interfaces. For example, in the illustrated embodiment, hardware accelerator 18 has four interfaces. The hardware accelerator 18 has an interface 161 (referred to as the “North Interface”) to communicate with media processor 14. The hardware accelerator 18 may receive commands and/or data from media processor 14 through interface 161. Additionally, the hardware accelerator 18 may include an interface 176 to bus 32. The bus 32 may connect the hardware accelerator 18 to boot PROM 30 and/or video output processor 24. The boot PROM 30 may be configured to store system initialization data and/or control code for frame buffer 22. The hardware accelerator 18 may also include an interface to a texture buffer 20. For example, the hardware accelerator 18 may interface to the texture buffer 20 using an eight-way interleaved texel bus that allows the hardware accelerator 18 to read from and write to the texture buffer 20. The hardware accelerator 18 may also interface to the frame buffer 22. For example, the hardware accelerator 18 may be configured to read from and/or write to the frame buffer 22 using a four-way interleaved pixel bus.

The vertex processor 162 may be configured to use the vertex tags received from the media processor 14 to perform ordered assembly of the vertex data from the MPUs 152. Vertices may be saved in and/or retrieved from a mesh buffer 164.

The render pipeline 166 may be configured to rasterize 2D window system primitives and 3D primitives into fragments. A fragment may contain one or more samples. Each sample may contain a vector of color data and perhaps other data such as alpha and control tags. 2D primitives include objects such as dots, fonts, Bresenham lines and 2D polygons. 3D primitives include objects such as smooth and large dots, smooth and wide DDA (Digital Differential Analyzer) lines and 3D polygons (e.g. 3D triangles).

For example, the render pipeline 166 may be configured to receive vertices defining a triangle, to identify fragments that intersect the triangle.

The render pipeline 166 may be configured to handle full-screen size primitives, to calculate plane and edge slopes, and to interpolate data (such as color) down to tile resolution (or fragment resolution) using interpolants or components such as:

r, g, b (i.e., red, green, and blue vertex color);

r2, g2, b2 (i.e., red, green, and blue specular color from lit textures);

alpha (i.e. transparency);

z (i.e. depth); and

s, t, r, and w (i.e. texture components).

In embodiments using supersampling, the sample generator 174 may be configured to generate samples from the fragments output by the render pipeline 166 and to determine which samples are inside the rasterization edge. Sample positions may be defined by user-loadable tables to enable stochastic sample-positioning patterns.

Hardware accelerator 18 may be configured to write textured fragments from 3D primitives to frame buffer 22. The render pipeline 166 may send pixel tiles defining r, s, t and w to the texture address unit 168. The texture address unit 168 may determine the set of neighboring texels that are addressed by the fragment(s), as well as the interpolation coefficients for the texture filter, and write texels to the texture buffer 20. The texture buffer 20 may be interleaved to obtain as many neighboring texels as possible in each clock. The texture filter 170 may perform bilinear, trilinear or quadlinear interpolation. The pixel transfer unit 182 may also scale and bias and/or lookup texels. The texture environment 180 may apply texels to samples produced by the sample generator 174. The texture environment 180 may also be used to perform geometric transformations on images (e.g., bilinear scale, rotate, flip) as well as to perform other image filtering operations on texture buffer image data (e.g., bicubic scale and convolutions).

In the illustrated embodiment, the pixel transfer MUX 178 controls the input to the pixel transfer unit 182. The pixel transfer unit 182 may selectively unpack pixel data received via north interface 161, select channels from either the frame buffer 22 or the texture buffer 20, or select data received from the texture filter 170 or a sample filter 172.

The pixel transfer unit 182 may be used to perform scale, bias, and/or color matrix operations, color lookup operations, histogram operations, accumulation operations, normalization operations, and/or min/max functions, among others. Depending on the source of (and operations performed on) the processed data, the pixel transfer unit 182 may output the processed data to the texture buffer 20 (via the texture buffer MUX 186), the frame buffer 22 (via the texture environment unit 180 and the fragment processor 184), or to the host (via the north interface 161). For example, in one embodiment, when the pixel transfer unit 182 receives pixel data from the host via the pixel transfer MUX 178, the pixel transfer unit 182 may be used to perform a scale and bias or color matrix operation, followed by a color lookup or histogram operation, followed by a min/max function. The pixel transfer unit 182 may then output data to either the texture buffer 20 or the frame buffer 22.

Fragment processor 184 may be used to perform standard fragment processing operations such as the OpenGL® fragment processing operations. For example, the fragment processor 184 may be configured to perform the following operations: fog, area pattern, scissor, alpha/color test, ownership test (WID), stencil test, depth test, alpha blends or logic ops (ROP), plane masking, buffer selection, pick hit/occlusion detection, and/or auxiliary clipping in order to accelerate overlapping windows, among others.

### Texture Buffer 20

Texture buffer 20 may include several SDRAMs. The texture buffer 20 may be configured to store texture maps, image processing buffers, and accumulation buffers for hardware accelerator 18. The texture buffer 20 may have many different capacities (e.g., depending on the type of SDRAM included in texture buffer 20). In some embodiments, each pair of SDRAMs may be independently row and column addressable.

### Frame Buffer 22

Graphics system 112 may also include a frame buffer 22. In one embodiment, frame buffer 22 may include multiple 3D-RAM memory devices (e.g. 3D-RAM64 memory devices) manufactured by Mitsubishi Electric Corporation. The frame buffer 22 may be configured as a display pixel buffer, an offscreen pixel buffer, and/or a supersample buffer. Furthermore, in one embodiment, certain portions of the frame buffer 22 may be used as a display pixel buffer, while other portions may be used as an offscreen pixel buffer and sample buffer.

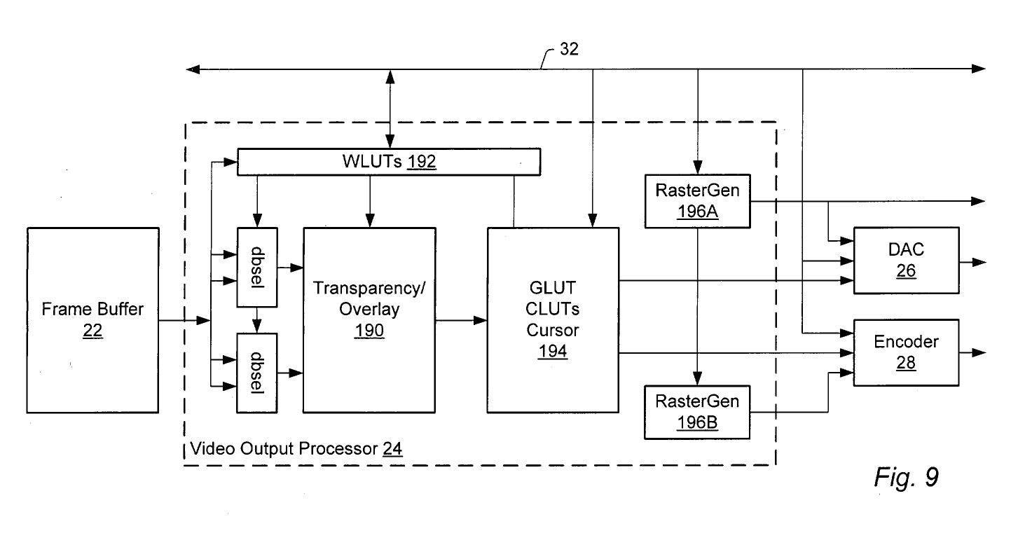

### Video Output Processor—FIG. 9

A video output processor 24 may also be included within graphics system 112, according to one embodiment. The video output processor 24 may buffer and process pixels output from a frame buffer 22. For example, the video output processor 24 may be configured to read bursts of pixels from the frame buffer 22. The video output processor 24 may also be configured to perform double buffer selection (dbsel) if the frame buffer 22 is double-buffered, overlay transparency (using transparency/overlay unit 190), plane group extraction, gamma correction, psuedocolor or color lookup or bypass, and/or cursor generation, among others. For example, in the illustrated embodiment, the output processor 24 includes WID (Window ID) lookup tables (WLUTs) 192 and gamma and color map lookup tables (GLUTs, CLUTs) 194. In one embodiment, the frame buffer 22 may include multiple 3DRAM64s 201 that include the transparency overlay 190 and all or some of the WLUTs 192. The video output processor 24 may also be configured to support two video output streams to two displays using the two independent video raster timing generators 196. For example, one raster (e.g., 196A) may drive a 1280×1024 CRT while the other (e.g., 196B) may drive a NTSC or PAL device with encoded television video.

DAC 26 may operate as the final output stage of the graphics system 112. The DAC 26 translates the digital pixel data received from GLUT/CLUTs/Cursor unit 194 into analog video signals that are then sent to a display device. In one embodiment, the DAC 26 may be bypassed or omitted completely in order to output digital pixel data in lieu of analog video signals. This may be useful when a display device is based on a digital technology (e.g., an LCD-type display or a digital micro-mirror display).

The DAC 26 may be a red-green-blue digital-to-analog converter configured to provide an analog video output to a display device such as a cathode ray tube (CRT) monitor. In one embodiment, the DAC 26 may be configured to provide a high resolution RGB analog video output at dot rates of 240 MHz. Similarly, an encoder 28 may be configured to supply an encoded video signal to a display. For example, the encoder 28 may provide encoded NTSC or PAL video to an S-Video or composite video television monitor or recording device.

In other embodiments, the video output processor 24 may output pixel data to other combinations of displays. For example, by outputting pixel data to two DACs 26 (instead of one DAC 26 and one encoder 28), the video output processor 24 may drive two CRTs. Alternately, by using two encoders 28, the video output processor 24 may supply appropriate video input to two television monitors. Generally, many different combinations of display devices may be supported by supplying the proper output device and/or converter for that display device.

### Sample-to-Pixel Processing Flow

In one set of embodiments, hardware accelerator 18 may receive geometric parameters defining primitives such as triangles from media processor 14, and render the primitives in terms of samples. The samples may be stored in a sample storage area (also referred to as the sample buffer) of frame buffer 22. The samples are then read from the sample storage area of the frame buffer 22 and filtered by a sample filter 172 to generate pixels. The pixels are stored in a pixel storage area of the frame buffer 22. The pixel storage area may be double-buffered. The video output processor 24 may read the pixels from the pixel storage area of the frame buffer 22 and may generate a video stream from the pixels. The video stream may be provided to one or more display devices (e.g. monitors, projectors, head-mounted displays, and so forth) through DAC 26 and/or video encoder 28.

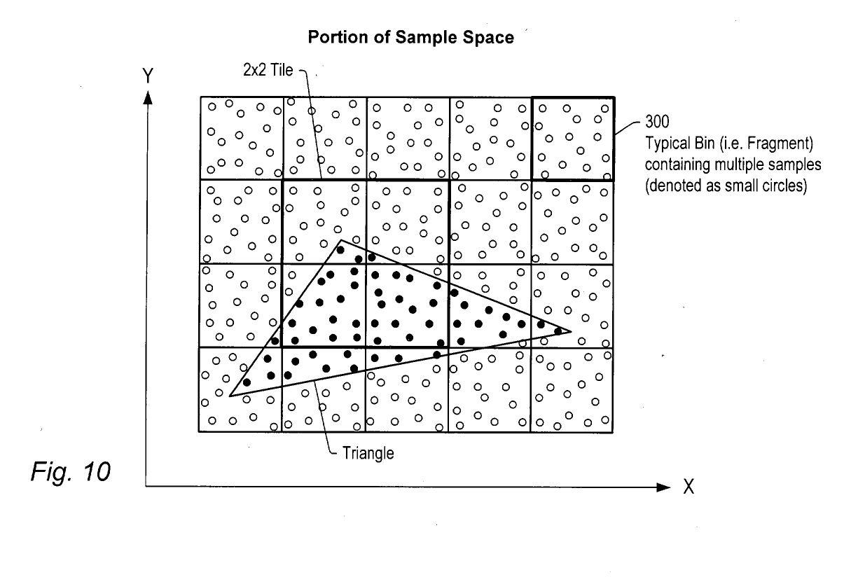

### Rendering of Samples in a Triangle—FIG. 10

FIG. 10 illustrates rendering of samples in a triangle, according to one embodiment. The samples are computed at positions in a two-dimensional sample space (also referred to as rendering space). The sample space may be partitioned into an array of bins (also referred to herein as fragments). The storage of samples in the sample storage area of a frame buffer 22 may be organized according to bins (e.g. bin 300). Each bin may contain one or more samples. The number of samples per bin may be a programmable parameter.

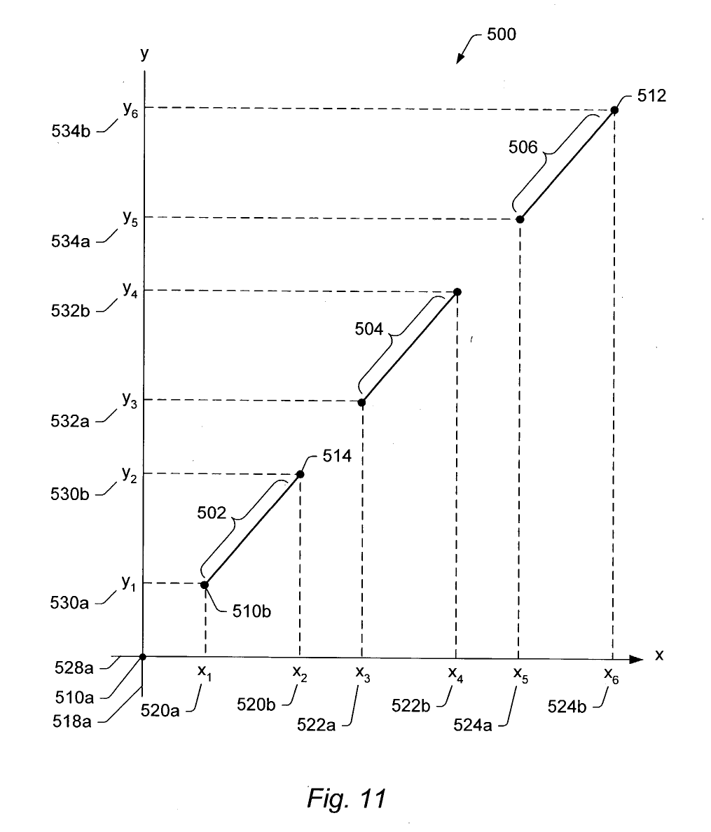

### An Exemplary Patterned Line—FIG. 11

FIG. 11 illustrates an exemplary patterned line, according to one embodiment. The exemplary patterned line 500 may include three line segments, a first line segment 502, a second line segment 504, and a third line segment 506. The exemplary patterned line 500, also referred to as a first line, may contain an original starting point 510a and an original endpoint 512. The original starting point 510a may include an x coordinate 518a and an y coordinate 528a. The original endpoint 512 may include an x coordinate 524b and an y coordinate 534b. The first line segment 502 may be rasterized from the new endpoint 514 to the new starting point 510b. The new endpoint 514 may include an x coordinate 520b and an y coordinate 530b. The new starting point 510b may include an x coordinate 520a and an y coordinate 530a.

### Line Rendering

One common function in graphics applications is drawing or rendering lines on the display. Some graphic systems are capable of drawing both anti-aliased and jaggy lines. Jaggy lines may “touch” fewer pixels (e.g., ⅓ fewer pixels) than anti-aliased lines and therefore may be drawn faster. In general, lines may be individual lines or polylines. A polyline or a patterned line generally refers to a line that includes a pattern, e.g., a dashed line, dotted line or other types of lines.

Anti-aliasing refers to a process whereby a filter may be applied to one or more pixels in a line to manipulate intensities of the pixels forming the line in order to produce a smoother line. In one embodiment, the system may perform anti-aliasing on lines using a three-pixel wide line filter based on a Gaussian curve (1.0/exp(d*d)), where d is distance from the line center. The pixel intensity may be determined by computing the distance of a pixel sample point along the minor axis from a center of the line and by looking up the filter weight value in a table. The pixel intensity may be multiplied by this filter weight value, reducing its intensity. The three pixels across the line should have the same apparent intensity as a one-pixel jaggy line, but without the aliasing artifacts.

When lines are drawn left to right, in many instances the location where two lines meet may involve multiple accesses to the same pixels in a frame buffer. When drawing anti-aliased lines, it may be undesirable to access the same pixel twice consecutively in the frame buffer. This is because, after a first read-modify-write operation, the pixel data may require at least several frame buffer clock cycles to flow through the frame buffer pipeline before the new data may be stored inside the frame buffer. A second read-modify-write operation may be issued to the same pixel only after the new data has been written in order to ensure data consistency between a write of the first read-modify-write and a read of the second read-modify-write. Hence, in any consecutive read-modify-write accesses to the same pixel location, a certain number of cycles may have to be inserted in between. In order to avoid this situation, anti-aliased lines may be drawn from end to start to avoid visiting the same pixel twice in a short time period.

Line patterning is a capability that allows a pattern to be applied to a continuous series of connected lines. This may be useful for identifying different lines, e.g., by giving each line a unique pattern. However, as described above, when anti-aliased lines are drawn, the anti-aliasing generally requires redrawing of the line endpoints to ensure that they blend properly. However, as described above, this typically involves issuing several write operations to the same pixel address in the same buffer in very short time periods. Sending a write to the same pixel address in the frame buffer too soon after a previous write to the same pixel address can lead to sub-optimal frame buffer performance. As noted in the background section, a solution to this problem has been to draw the lines backwards starting at the end point and then drawing to the start point. However, when line patterning is being performed, the pattern is drawn backwards. This may result in the undesirable effect that the pattern is drawn backwards from the manner in which the user desires or specifies the line. Further, the drawn pattern may not be seamless and may not appear correct to the user because the line segments may not meet properly. This may result in visual artifacts in the line being drawn.

One embodiment of the method for line patterning uses the specified line pattern to determine a starting point and an endpoint of each line segment, thus indicating rendering of a pixel in the patterned line. Each segmented line may then be drawn from the endpoint to starting point in a right to left fashion, but with the rendered result appearing as if each of the segmented lines were drawn left to right.

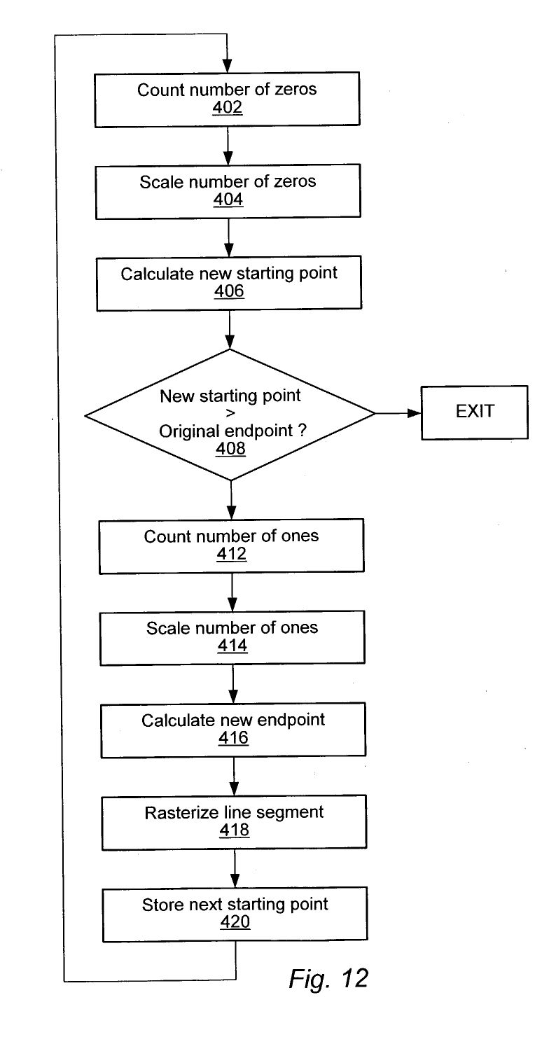

### Method for Line Patterning—FIG. 12

FIG. 12 is a flowchart diagram illustrating one embodiment of a method for line patterning. In one embodiment, the line patterning method, also referred to herein as the line patterning algorithm, may be used in a graphics system. The graphics system may be operable to process a plurality of patterned lines. The plurality of patterned lines may include a first line, such as the patterned line described above with reference to FIG. 11. The graphics system may process line data by using the line patterning algorithm such as described herein. The line data for the first line may include an original starting point 510a and an original endpoint 512. The first line may be divided by the line patterning algorithm into one or more line segments, such as a first line segment, a second line segment, and a third line segment, such as described above with reference to FIG. 11.

In one embodiment, the original starting point may contain x and y coordinates, such as described above with reference to FIG. 11. In one embodiment, the original endpoint may contain x and y coordinates, such as described above with reference to FIG. 11. In one embodiment, the new starting point may include x and y coordinates, such as described above with reference to FIG. 11. In one embodiment, the new endpoint may include x and y coordinates, such as described above with reference to FIG. 11.

In one embodiment, the line data for the first line may include line scale data for the first line, where the line scale data may be operable to scale the first line. In one embodiment, the line data for the first line includes line slope of the first line. For example, referring back to FIG. 11, the slope of the first line may be [(y₆−y₁)/(x₆−x₁)]. Each one of the first, second, and third line segments generated by dividing the first line into one or more line segments may have the same slope as the first line. In one embodiment, the line data for the first line may include one or more of a starting color value and a color slope. The starting color value may indicate the color of the original starting point of the first line, and the color slope may indicate the color slope of the first line from the original starting point to the original endpoint.

In one embodiment, in 402 a number of consecutive zeros in the patterned line may be counted, starting at the original starting point. If one or more zeros are present at the beginning of the pattern, then these zeros may be counted to generate the number of zeros. For example, in a pattern ‘0011’, two zeros may be counted. In another example, for a pattern of ‘011’, one zero may be counted. In one embodiment, if the pattern begins with a ‘1’, then no zeros may be counted. For example, in a pattern ‘100’, no zeros may be counted.

In 404, the number of zeros may be scaled based on the line scale data to produce a scaled number of zeros. For example, if the line scale data is 5, then the number of zeros may be multiplied by 5 to produce the scaled number of zeros. In such example, line pattern data of ‘0011’ may result in a number of zeros of 2. Furthermore, scaling of the number of zeros with a line scale data of 5 may produce 10 zeros.

In 406 the original starting point may be adjusted by a scaled number of zeros, such as the scaled number of zeros generated in 404. Thus, in the above example with a pattern of ‘0011’ and line scale data of five, the original starting point may be adjusted from 1 to 11, where 11 is the new starting point. In one embodiment, a new starting color value may also be calculated in 406. The new starting color value calculation may include adjusting the starting color value by one or more of the scaled number of zeros and the color slope of the first line.

In one embodiment, the x coordinate of the original starting point may be adjusted by the scaled number of zeros to generate the x coordinate of the new starting point. The y coordinate of the original starting point may be adjusted by the scaled number of zeros to generate the y coordinate of the new starting point.

In 408, a check may be performed to determine if location of the new starting point exceeds location of the original endpoint. In other words, the check in 408 may determine if an entire line has been drawn. If the new starting point exceeds the location of the original endpoint, then operation may complete and exit. If the new starting point does not exceed the original endpoint, then the operation may proceed to 412. In one embodiment, the x coordinate of the original endpoint may be compared to the x coordinate of the new endpoint. If the x coordinate of the new endpoint is greater than the x coordinate of the original endpoint, then the x coordinate of the new endpoint may be set to the x coordinate of the original endpoint.

In 412, a consecutive number of ones may be counted in the line pattern data for the first line to generate a number of ones. Specifically, the consecutive number of ones that either begin the pattern or are after the previously counted zeros in the pattern may be counted. For example, for line pattern data containing ‘0011’, the number of ones may be two. In another example, for line pattern data containing ‘100’, the number of ones may be one.

In 414, the number of ones may be scaled based on the line scale data for the first line. For example, if the line data for the first line contains ‘0011’, the number of ones is two, and the line scale data is 5, then scaling the number of ones may produce ten ones.

In 416, the new endpoint may be calculated. The new endpoint may be calculated by adjusting the original starting point by the scaled number of ones. For example, for the example given above with a pattern of ‘0011’, the starting point may be adjusted to 11 and the endpoint may be adjusted to 20. In one embodiment, the x coordinate of the new endpoint may be calculated by adjusting the x coordinate of the original endpoint by the scaled number of ones. The y coordinate of the new endpoint may be calculated by adjusting the y coordinate of the original endpoint point by the scaled number of ones. In one embodiment, the new endpoint may be calculated by adjusting the y coordinate of the original endpoint by one or more of the scaled number of ones and slope of the first line.

In 418, the first line segment may be rasterized from the new endpoint to the new starting point. In other words, the first line segment may be rasterized from right to left, thus avoiding problems associated with multiple consecutive accesses of pixel addresses in the pixel buffer. However, the method described herein operates to draw or render the line as if the line were being drawn left to right. In other words, the original or intended line pattern of the line is preserved since the zeros and ones are drawn or rendered in their appropriate locations as if they were being drawn left to right, even though they are actually rasterized from right to left.

In 420, the new endpoint may be used as the next starting point for the next iteration of the line patterning algorithm. In other words, the new endpoint may be used as the next original starting point for the second line segment, such as the new endpoint 514 may be used as the next original starting point for the second line segment 504, such as described above with reference to FIG. 11.

It is noted that the flowchart of FIG. 12 is exemplary only. Further, various steps in the flowchart of FIG. 12 may occur concurrently or in different order than that shown, or may not be performed, as desired. Also, various additional steps may be performed as desired.

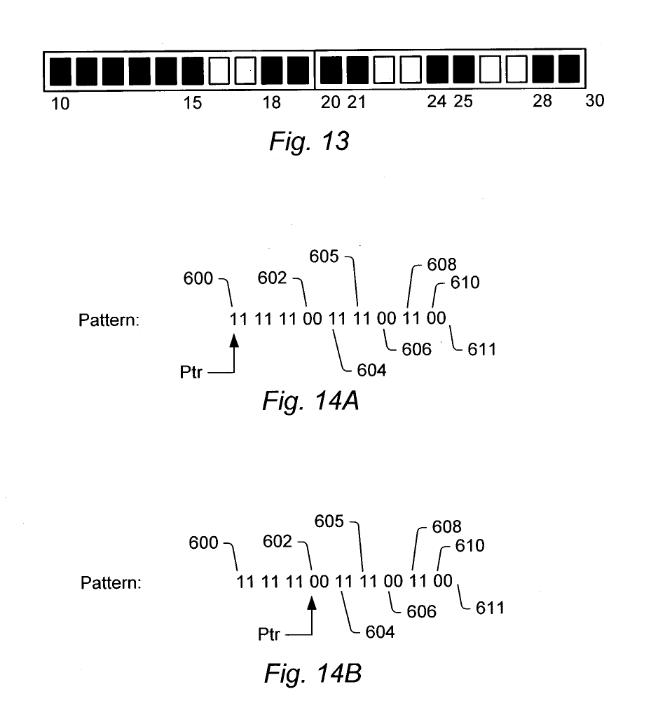

### Exemplary 1-D Patterned Line—FIG. 13

FIG. 13 illustrates an exemplary 1-D patterned line, also referred to herein as the first line, according to one embodiment. In this example, line data for the first line may contain line pattern data of ‘111011000000000’. For the purpose of this example, the line data contains line scale data of 2. In one embodiment, the line data also contains line length data, where line length data is operable to specify how many bits of the line pattern data should be used for the first line. In this example, the line length data is 9. In other words, only the first 9 bits of the pattern may be used for the first line. Since line scale data is 2, every bit in the line pattern data should be duplicated for the first line. In one embodiment, each line can have a maximum of 10 bits. Using a previous technique, such as one described above with reference to FIG. 3, the first line may be divided into two lines: (10,10) to (20,10) and (20,10) to (30,10).

However, in one embodiment of the line patterning algorithm, the first line may be divided into five line segments: [10,16), [18,20), [20,22), [24,26), [28,30). In other embodiments, the first line may be divided into four line segments: [10,16), [18,22), [24,26), [28,30), depending on the capability of the graphics system to process certain length line segments.

### Exemplary Segmentation of a 1-D patterned Line Into one or More Segments—FIGS. 14A and 14B

FIGS. 14A and 14B illustrate exemplary segmentation of an exemplary 1-D patterned line into one or more segments, according to one embodiment. Line data for the exemplary 1-D line may include an original starting point and an original endpoint. In one embodiment, a pointer may keep track of where the line patterning algorithm is in the pattern. The pointer may start at the original starting point, such as illustrated in FIG. 14A.

First, a consecutive number of zeros may be counted, such as described above with reference to FIG. 12. In one embodiment, the counting of zeros may start at the pointer, which may point at the original starting point (location 600). In this example, there are no leading zeros. Therefore the number of zeros for this example may be zero. A new starting point may be calculated, and it may be the same as the original starting point, since there are no leading consecutive zeros in this exemplary pattern. Next, a consecutive number of ones may be counted. In one embodiment, the counting of ones may start at the pointer, or the new starting point. In this example, there may be 6 ones. Next, a new endpoint may be calculated. In this example, the new endpoint may be the first zero after a pattern of six ones at the location of 602, such as illustrated in FIG. 14B.

Next, the new endpoint may be compared with the original endpoint to make sure that the new endpoint does not extend beyond the original endpoint. In this-example, the original endpoint may be at location 605. In other embodiments, the original endpoint may be at location 611, depending on a maximum length of each line. In one embodiment, a location of an original endpoint for a line in line data may be exclusive, meaning the line may end one bit before the original endpoint.

By generating the new starting point at location 600 and the new endpoint at location 602, a first line segment for the exemplary 1-D line may be generated. The first line segment may be rasterized from the new endpoint to the new starting point. Next, the line patterning algorithm may start for a second line segment for the exemplary 1-D line. Initially, the second line segment may have an original starting point at location 602 and an original endpoint at location 605 or 606, depending on the maximum length of each line.

It is noted that FIGS. 14A and 14B are exemplary only. Further, various steps in FIGS. 14A and 14B may occur concurrently or in different order than that shown, or may not be performed, as desired. Also, various additional steps may be performed as desired.

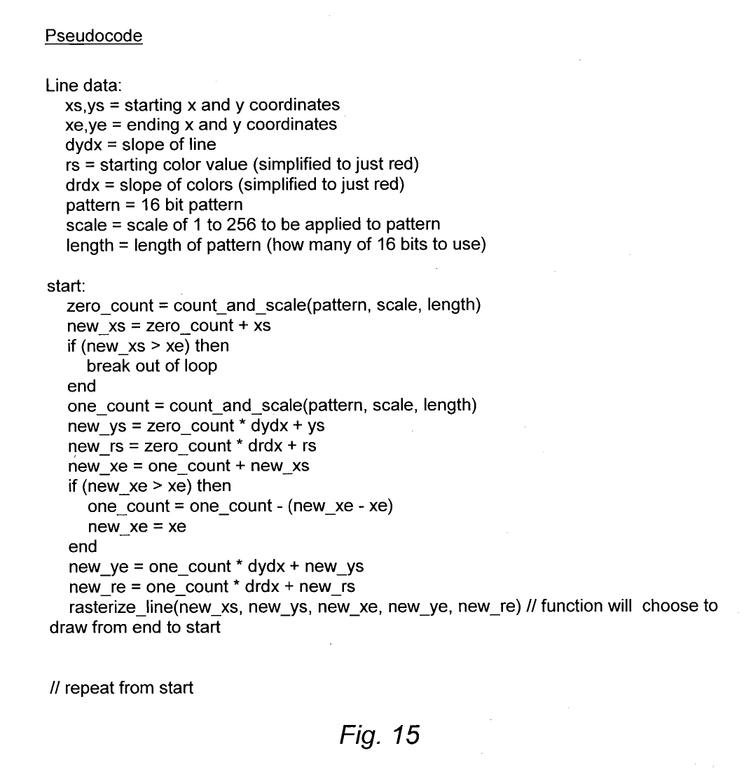

### Sample Pseudo-Code—FIG. 15

FIG. 15 contains sample pseudocode for one embodiment of a line patterning algorithm. FIG. 15 illustrates a 2-D implementation of the line patterning algorithm.

It is noted that the pseudocode of FIG. 15 is exemplary only. Further, various steps in the pseudocode of FIG. 15 may occur concurrently or in different order than that shown, or may not be performed, as desired. Also, various additional steps may be performed as desired.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

1. A method for line patterning, the method comprising:
receiving line data for a first line, wherein the line data comprises line pattern data, wherein the line data for the first line comprises an original starting point and an original endpoint, wherein the line pattern data indicates a pattern of the first line;
dividing the first line into one or more line segments, wherein dividing the first line into the one or more line segments comprises generating a new starting point and a new endpoint for one or more of the one or more line segments;
rasterizing the one or more of the one or more line segments using the new starting point and the new endpoint for the one or more of the one or more line segments.

2. The method of claim 1,
wherein said dividing the first line into the one or more line segments further comprises:
starting at the original starting point, counting consecutive zeros in the line pattern data to generate a number of zeros;
adjusting the original starting point in the line data by the number of zeros to generate a new starting point for a first line segment for the first line;
starting at the new starting point, counting consecutive ones in the line pattern data to generate a number of ones; and
calculating a new endpoint for the first line segment for the first line.

3. The method of claim 2,
wherein said adjusting the original starting point in the line data comprises comparing the new starting point to the original endpoint, wherein the first line is null if the new starting point is greater than the original endpoint.

4. The method of claim 2, further comprising:
using the new endpoint as a next original starting point, repeating said counting consecutive zeros, said adjusting the original starting point, said counting consecutive ones, and said calculating the new endpoint for a second line segment for the first line.

5. The method of claim 2,
wherein the line pattern data further comprises digital data, wherein the digital data comprises one or more bits, wherein each one of the one or more bits comprises a zero or a one, wherein the one or more bits indicate the pattern of the first line.

6. The method of claim 5,
wherein the line data further comprises line scale data;
wherein the line scale data is operable to scale the one or more bits in the pattern of the first line.

7. The method of claim 6, further comprising:
scaling the number of zeros by the line scale data to generate a scaled number of zeros.

8. The method of claim 7,
wherein said adjusting the original starting point comprises adjusting the original starting point by the scaled number of zeros to generate the new starting point.

9. The method of claim 7,
wherein the original starting point comprises an x coordinate of the original starting point and an y coordinate of the original starting point;
wherein the original endpoint comprises an x coordinate of the original endpoint and an y coordinate of the original endpoint;
wherein the new starting point comprises an x coordinate of the new starting point and an y coordinate of the new starting point; and
wherein the new endpoint comprises an x coordinate of the new endpoint and an y coordinate of the new endpoint.

10. The method of claim 9,
wherein the line data further comprises slope of the first line.

11. The method of claim 10,
wherein said adjusting the original starting point further comprises adjusting the y coordinate of the original starting point by one or more of the scaled number of zeros and the slope of the first line to generate the y coordinate of the new starting point.

12. The method of claim 9,
wherein the line data further comprises one or more of a starting color value and color slope of the first line.

13. The method of claim 12, further comprising:
calculating a new starting color value, wherein said calculating the new starting color value comprises adjusting the starting color value by one or more of the scaled number of zeros and the color slope of the first line.

14. The method of claim 9, further comprising:
wherein said adjusting the original starting point further comprises adjusting the x coordinate of the original starting point by the scaled number of zeros to generate the x coordinate of the new starting point; and
wherein said adjusting the original starting point further comprises adjusting the y coordinate of the original starting point by the scaled number of zeros to generate the y coordinate of the new starting point.

15. The method of claim 9, further comprising:
scaling the number of ones by the line scale data to produce a scaled number of ones;
wherein said calculating the new endpoint comprises adjusting the x coordinate of the original endpoint by the scaled number of ones to generate the x coordinate of the new endpoint; and
wherein said calculating the new endpoint point further comprises adjusting the y coordinate of the original endpoint point by the scaled number of ones to generate the y coordinate of the new endpoint.

16. The method of claim 15,
wherein said adjusting the x coordinate of the original endpoint comprises comparing the x coordinate of the original endpoint to the x coordinate of the new endpoint, wherein the x coordinate of the new endpoint is set to the x coordinate of the original endpoint if the x coordinate of the new endpoint is greater than the x coordinate of the original endpoint.

17. The method of claim 15,
wherein the line data further comprises slope of the first line; and
wherein said calculating the new endpoint further comprises adjusting the y coordinate of the original endpoint by one or more of the scaled number of ones and the slope of the first line to generate the y coordinate of the new endpoint.

18. The method of claim 6, further comprising:
scaling the number of ones by the line scale data to generate a scaled number of ones;
wherein said calculating the new endpoint comprises adjusting the original endpoint by the scaled number of ones to generate the new endpoint.

19. The method of claim 18,
wherein the new endpoint is set to the original endpoint if the new endpoint is greater than the original endpoint.

20. The method of claim 2,
wherein the method for line patterning is operable to be used in a graphics system.

21. The method of claim 2,
wherein the method for line patterning is operable to divide the first line into a plurality of line segments, wherein one or more of the plurality of line segments is operable to be anti-aliased.

22. The method of claim 2,
wherein the line data further comprises line length data, wherein the line length data is operable to indicate the length of the line pattern data used for the first line.

23. The method of claim 1,
wherein said rasterizing comprises rasterizing the one or more of the one or more line segments from the new endpoint to the the new starting point.

24. The method of claim 1,
wherein said rasterizing comprises avoiding consecutively accessing same pixel in the first line.

25. A method for line patterning, the method comprising:
receiving line data for a first line, wherein the line data comprises line pattern data, wherein the line data further comprises an original starting point and an original endpoint for the first line, wherein the line pattern data indicates a pattern of the first line;
starting at the original starting point, counting consecutive zeros in the line pattern data to generate a number of zeros;
adjusting the original starting point in the line data by the number of zeros to generate a new starting point;
starting at the new starting point, counting consecutive ones in the line pattern data to generate a number of ones;
calculating a new endpoint to produce a first line segment for the first line; and
rasterizing the first line segment for the first line from the new endpoint to the new starting point.

26. The method of claim 25,
wherein said adjusting the original starting point in the line data comprises comparing the new starting point to the original endpoint, wherein the first line is null if the new starting point is greater than the original endpoint.

27. The method of claim 25, further comprising:
using the new endpoint as a next original starting point, repeating said counting consecutive zeros, said adjusting the original starting point, said counting consecutive ones, said calculating the new endpoint, and said rasterizing the line segment for a second line segment for the first line.

28. The method of claim 25, further comprising:
dividing the first line into one or more line segments.

29. The method of claim 25,
wherein the line pattern data further comprises digital data, wherein the digital data comprises one or more bits, wherein each one of the one or more bits comprises a zero or a one, wherein the one or more bits indicate the pattern of the first line.

30. The method of claim 29,
wherein the line data further comprises line scale data;
wherein the line scale data is operable to scale the one or more bits in the pattern of the first line.

31. The method of claim 30, further comprising:
scaling the number of zeros by the line scale data to generate a scaled number of zeros.

32. The method of claim 31,
wherein said adjusting the original starting point comprises adjusting the original starting point by the scaled number of zeros to generate the new starting point.

33. The method of claim 31,
wherein the original starting point comprises an x coordinate of the original starting point and an y coordinate of the original starting point;
wherein the original endpoint comprises an x coordinate of the original endpoint and an y coordinate of the original endpoint;
wherein the new starting point comprises an x coordinate of the new starting point and an y coordinate of the new starting point; and
wherein the new endpoint comprises an x coordinate of the new endpoint and an y coordinate of the new endpoint

34. The method of claim 33,
wherein the line data for the first line further comprises slope of the first line.

35. The method of claim 34,
wherein said adjusting the original starting point further comprises adjusting the y coordinate of the original starting point by one or more of the scaled number of zeros and the slope of the first line to generate the y coordinate of the new starting point.

36. The method of claim 33,
wherein the line data for the first line further comprises one or more of a starting color value and color slope of the first line.

37. The method of claim 36, further comprising:
calculating a new starting color value, wherein said calculating the new starting color value comprises adjusting the starting color value by one or more of the scaled number of zeros and the color slope of the first line.

38. The method of claim 33, further comprising:
wherein said adjusting the original starting point further comprises adjusting the x coordinate of the original starting point by the scaled number of zeros to generate the x coordinate of the new starting point; and
wherein said adjusting the original starting point further comprises adjusting the y coordinate of the original starting point by the scaled number of zeros to generate the y coordinate of the new starting point.

39. The method of claim 33, further comprising:
scaling the number of ones by the line scale data to produce a scaled number of ones;
wherein said calculating the new endpoint comprises adjusting the x coordinate of the original endpoint by the scaled number of ones to generate the x coordinate of the new endpoint; and
wherein said calculating the new endpoint point further comprises adjusting the y coordinate of the original endpoint point by the scaled number of ones to generate the y coordinate of the new endpoint.

40. The method of claim 39,
wherein said adjusting the x coordinate of the original endpoint comprises comparing the x coordinate of the original endpoint to the x coordinate of the new endpoint, wherein the x coordinate of the new endpoint is set to the x coordinate of the original endpoint if the x coordinate of the new endpoint is greater than the x coordinate of the original endpoint.

41. The method of claim 39,
wherein the line data further comprises slope of the first line; and
wherein said calculating the new endpoint further comprises adjusting the y coordinate of the original endpoint by one or more of the scaled number of ones and the slope of the first line to generate the y coordinate of the new endpoint.

42. The method of claim 30, further comprising:
scaling the number of ones by the line scale data to generate a scaled number of ones;
wherein said calculating the new endpoint comprises adjusting the original endpoint by the scaled number of ones to generate the new endpoint.

43. The method of claim 42,
wherein the new endpoint is set to the original endpoint if the new endpoint is greater than the original endpoint.

44. The method of claim 25,
wherein the method for line patterning is operable to be used in a graphics system.

45. The method of claim 25,
wherein the method for line patterning is operable to divide one or more lines into a plurality of line segments, wherein one or more of the plurality of line segments is operable to be anti-aliased.

46. The method of claim 25,
wherein the line data further comprises line length data, wherein the line length data is operable to indicate the length of the line pattern data used for the first line.

47. The method of claim 25,
wherein said rasterizing comprises avoiding consecutively accessing same pixel in the first line.
